(19) United States
(12) Patent Application Publication
(10) Pub. No.: US 2008/0303288 A1
(43) Pub. Date: Dec. 11, 2008

(54) Device and System for Producing Regenerative and Renewable Energy From Wind

(76) Inventor: Georg Hamann, Schleching (DE)

Correspondence Address: MOORE & VAN ALLEN PLLC, P.O. BOX 13706, Research Triangle Park, NC, 27709, US

(21) Appl. No.: 12/159,434

(22) PCT Filed: Dec. 28, 2006
(86) PCT No.: PCT/EP2006/012585

§ 371 Date: Jun. 27, 2008

(30) Foreign Application Priority Data
Dec. 29, 2005 (DE) 10 2005 062 908.3

(51) Int. Cl. F03D 9/00; F03B 17/04

(52) U.S. Cl. 290/55; 415/916

(57) ABSTRACT

The invention relates to a device for producing regenerative and renewable from wind, comprising at least one generator for producing electric energy, and a drive shaft which is connected to the generator and which comprises a plurality of blades which are set rotating by the passing air. The blades are arranged offset in relation to each other and along the drive shaft. The invention also relates to a system which consists of a plurality of said inventive devices.

The present invention relates to a wind-powered device for producing regenerative and renewable energy as set forth in the preamble of claim 1.

The present invention relates furthermore to a wind-powered system for producing regenerative and renewable energy, comprising a plurality of such devices.

In recent years a wealth of different devices and systems for generating energy have become known, based on exploiting wind power. Both on land and also offshore single wind turbines or complete wind farms comprising a plurality of wind turbines have been installed to drive generators to supply electrical energy by rotating in the passing wind.

However, individual wind turbines or wind power systems combined as wind farms pose many drawbacks. The wind turbines need to be rigidly tethered in the ground, requiring a corresponding structure therefor which is extremely expensive to the demise or even a negative outcome of a cost/benefits analysis.

On top of this, individual wind turbines or whole wind farms pose substantial environmental problems, especially in the countyside, but also offshore because they disfigure the landscape and seascape.

This is why the present invention is based on the object of providing a wind-powered device for producing regenerative and renewable energy which excels by being particularly compatible with the environment and which is simply structured and simple to install whilst being exceptionally efficient in the face of differing wind availability conditions.

Furthermore, the intention is to provide a system with such devices for a corresponding modular configuration.

The wind-powered device for producing regenerative and renewable energy comprises at least one generator for producing electrical energy, and a drive shaft which is connected to the generator and which comprises a plurality of blades which are set rotating by the passing air. By the blades being arranged interstaggered along the drive shaft, the pressure exerted by the passing air is optimally exploited, resulting in a surprisingly high rotary speed of the drive shaft and a high torque.

The wind-powered device in accordance with the invention for producing regenerative and renewable energy achieves a wealth of advantages, including:
simple and easy to install without involving construction activities;
regional basic supply possible by being sited near to power consumers;
universal and, where necessary, automatic adaptation of the device to existing flow conditions in thus assuring optimized response of the device in accordance with the invention;
environment friendly energy production;
device can be sized optimized to the energy supply required, for example case-sized set for siting in remote communities and the like;
zero-emission energy production.

To advantage the blades are configured repeller-type, i.e. having a configuration similar to that of propellers which by definition serve to propel (for example an aircraft or ship) whereas repellers are powered by the surrounding flow of the medium. The term “repeller-type” is understood to be repellers which may comprise one, two or also more blades.

Advantageously in accordance with the invention the pitch of the blades is interadjustable to optimize exploitation of the passing air flow, whereby the pitch of the blades along the drive shaft may differ one from the other.

It is furthermore of advantage that the spacing of the blades is adjustable in the longitudinal direction of the drive shaft as may differ or not be constant.

It is also furthermore of advantage that the pitch of the blade face is adjustable relative to the drive shaft, resulting in the blade face being positionable in accordance with the pressure of incident air flow and as may differ over the length of the drive shaft. Positioning may be done computer-controlled and/or by mechanical, electromechanical, pneumatic or hydraulic means.

Due to the blades being releasably fitted to the drive shaft blades having become worn out or damaged can be speedily replaced new.

In a first preferred embodiment the drive shaft is directly connected to the generator in powering it directly. As an alternative the drive shaft can be connected to the generator also via a suitable gearbox.

Due to the drive shaft being mounted in a frame, for example, rectangular in shape, all the advantages of a simple, compact, structure designed for facilitated shipment and installation are achieved. It is also to advantage that the generator can also be mounted on the frame.

It is furthermore of advantage that the frame is arranged substantially horizontal rotatable about a vertical axis, so that the device can always be optimally adapted to changes in the wind direction.

When the device comprises a drive shaft and a duct surrounding the blades there is the advantage of ducting the air targetted and adjustable, where necessary. The duct can extend along the drive shaft with a constant diameter or with a tapered diameter from the air inlet end to the air outlet end.

To advantage the device in accordance with the invention can be arranged above the hull of a ship comprising one or more buoyancy objects or floats and preferably a tether. The huge benefit of this is that the device floats on the water making it possible to locate the device in accordance with the invention offshore without further construction activities, it also being simple to locate it in place by suitable tethering means so that the device can be put to use for generating electrical energy again directly without cost-intensive construction actvities.

This is further supported by the device comprising a self-orienting rudder assembly.

As commented above, the device for producing energy in accordance with the invention results in substantial rotational velocities which may cause vibrations. To advantage, therefore, the drive shaft runs in bearings at both ends as well as at least one further location, for example at two to five locations, between the ends, resulting, on the one hand, in the complete device gaining in rigidity and, on the other, in rotation of the drive shaft substantially less or even free of vibrations.

To advantage oil-less, sealed-for-life plain or ball bearings also made of plastics or ceramics are provided as the drive shaft bearings, because they, on the one hand, feature a long life, and, on the other, requiring no maintenance.

It is furthermore to advantage that the drive shaft is engineered as a splined shaft and the mount of each blade as a splined mount. This achieves a system for fitting the blades to the drive shaft which is simple, effective and easy to adjust whist ensuring their stable running at the drive shaft for smooth power transfer to the drive shaft.

By a mesh cage provided surrounding the device it is protected from flying objects such as, for example, falling leaves, or also birds.

A particularly advantageous configuration of the blades materializes in that two each blades offset by 180° form a common tubular profile comprising a cavity in which a fluid is accommodated. In this arrangement the fluid does not fill the cavity completely, preferably substantially half of the cavity which is configured symmetrical in the two halves of the blade. When the cavity is located horizontal essentially the same amount of fluid is in both halves of the cavity. On further rotation of the blades the fluid is suddenly accelerated by the force of gravity causing the blades to rotate further. With a plurality of tubular profile blades a constant rotary speed and a substantially constant torque materializes. Although the fluid is water to advantage, any other suitable fluid can be employed.

This configuration is particularly suitable when the air flow is weak because only a low amount of driving energy is needed from without to cause the blades to rotate.

Another object of the present invention is a wind-powered system for producing regenerative and renewable energy, characterized in that it comprises a plurality of devices as set forth in any of the claims 1 to 20 arranged one behind the other and/or alongside each other and/or above each other.

One such system can thus be engineered modulized to be universally adaptable to the application conditions.

In one special embodiment the drive shafts of the devices are also interconnected universally to thus drive a generator in common.

Furthermore the present invention also involves use of one or more devices in accordance with the invention as well as use of a system in accordance with the invention for propelling a ship. The energy generated by the device or system in accordance with the invention may serve to power electric motors which in turn drive the screws propelling the ship as may be achieved directly or via accumulators charged by the device or system in accordance with the invention.

Furthermore the device or system in accordance with the invention may serve instead of, or also in addition thereto, to meet the electrical energy requirement of a passenger ship and/or cargo vessel.

In all, the device or system in accordance with the invention finds universal application both immobile as well as in mobile land, air and water craft.

Further details, features and advantages read from the following description with reference to the attached drawings in which

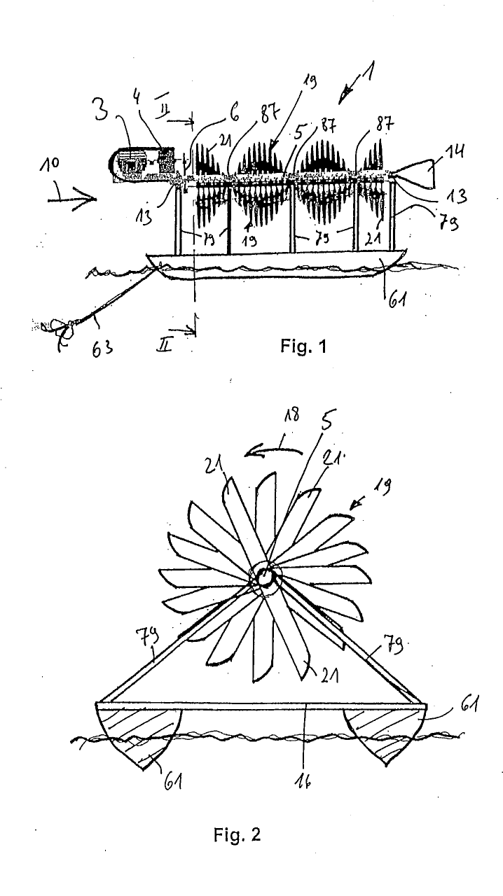

FIG. 1 is a side view of a first embodiment of the device in accordance with the invention for producing regenerative and renewable energy;

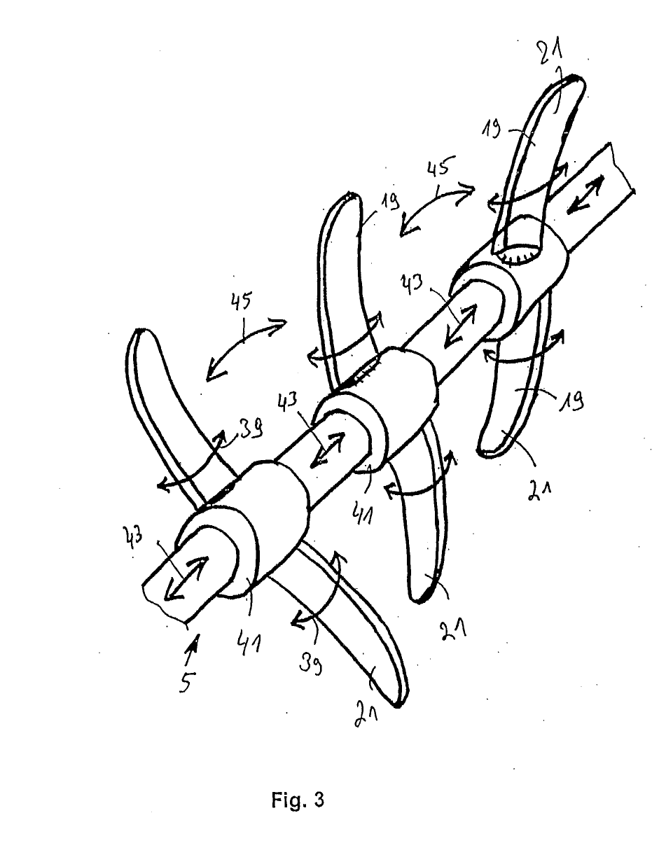

FIG. 2 is a diagrammatic side view taken along the line II-II in FIG. 1;

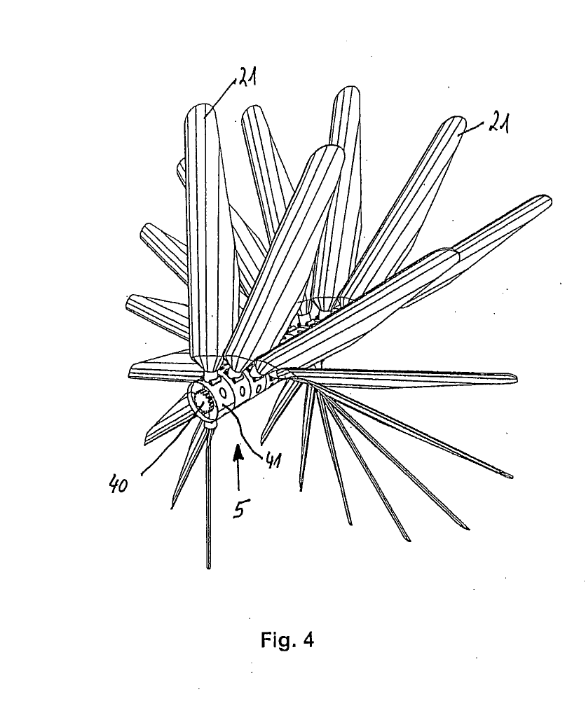

FIG. 3 is a diagrammatic partial view of the drive shaft with blades of the device in accordance with the invention;

FIG. 4 is partial view in perspective of a design aspect of the drive shaft with blades and their bearing;

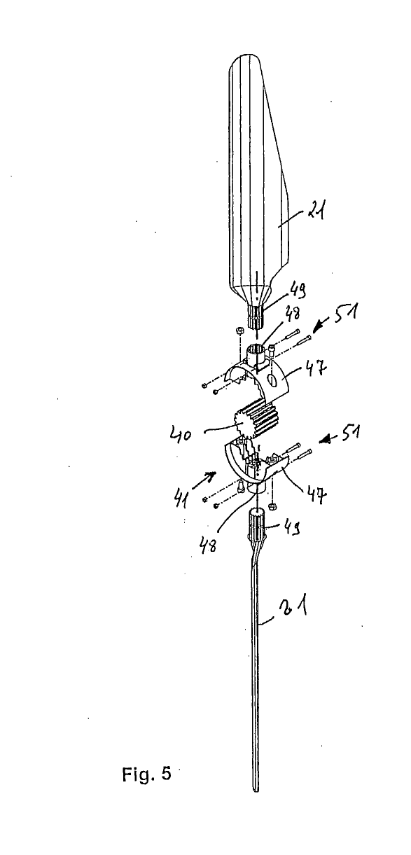

FIG. 5 is an exploded view of a bearing portion of two blades on the drive shaft;

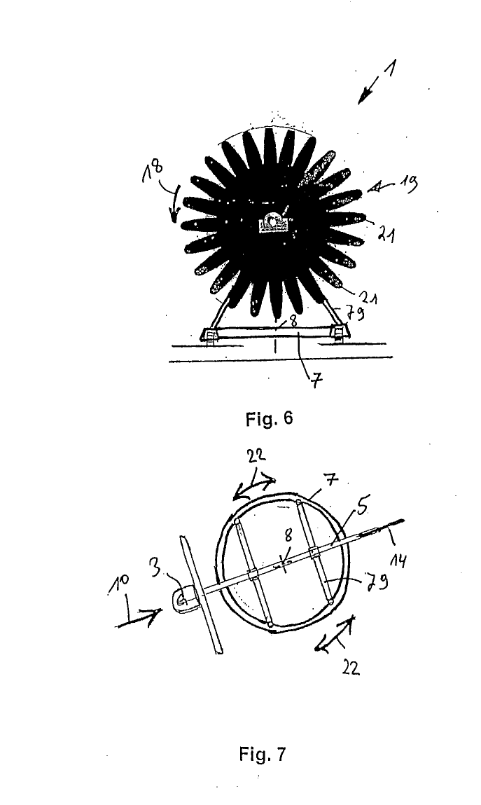

FIG. 6 is a diagrammatic front view of a further embodiment of the device in accordance with the invention;

FIG. 7 is a diagrammatic top-down view of a rotatable frame of the device in accordance with the invention;

FIG. 8 is a view in perspective of a further embodiment of the drive shaft of the device in accordance with the invention with tubular blades;

FIG. 9 is a front view of the embodiment as shown in FIG. 8;

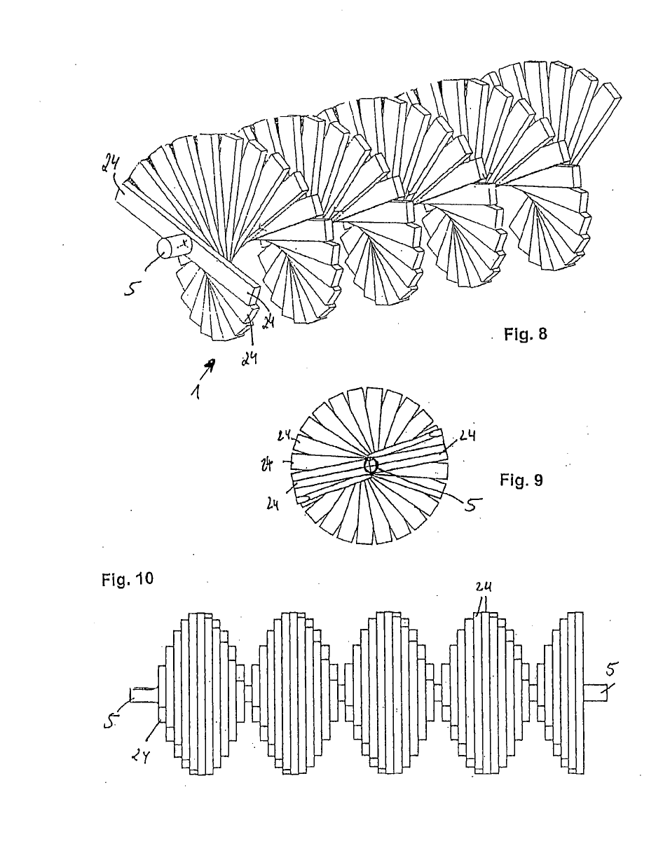

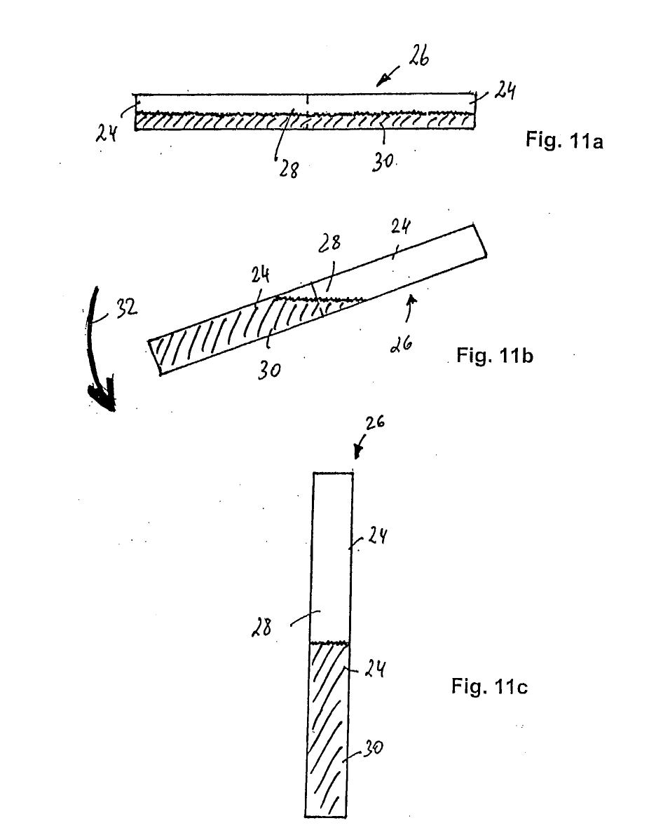

FIG. 10 is a side view of the embodiment as set forth in FIG. 8;

FIGS. 11a to 11c are each a magnified diagrammtic view of one embodiment of the tubular blades;

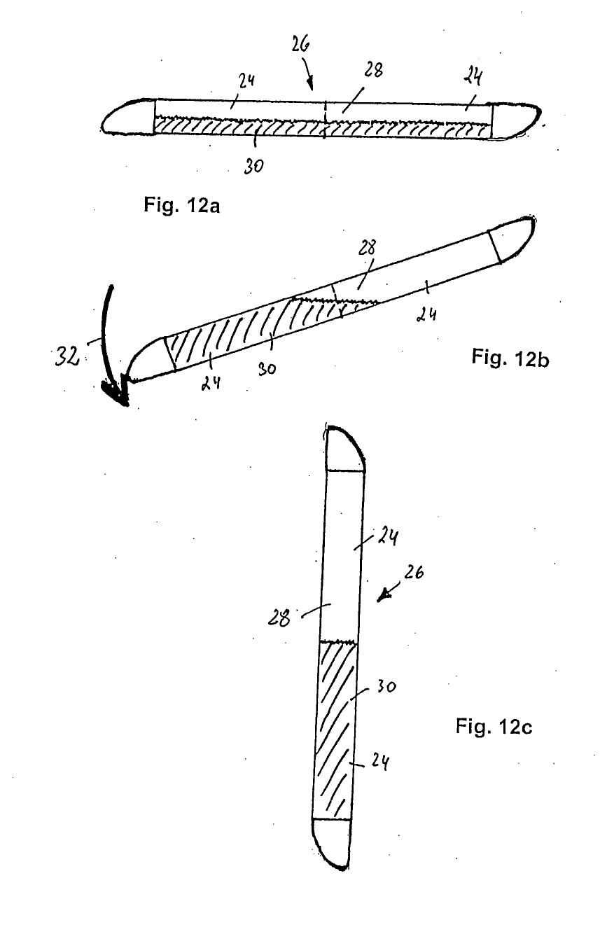

FIGS. 12a to 12c are each a view of an aspect variant of the blades as shown in FIGS. 11a to 11c;

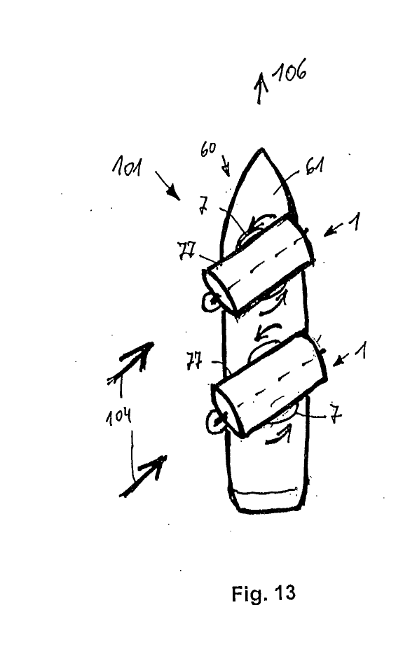

FIG. 13 is a diagrammatic top-down view of a first embodiment of the system in accordance with the invention with a hull featuring one float;

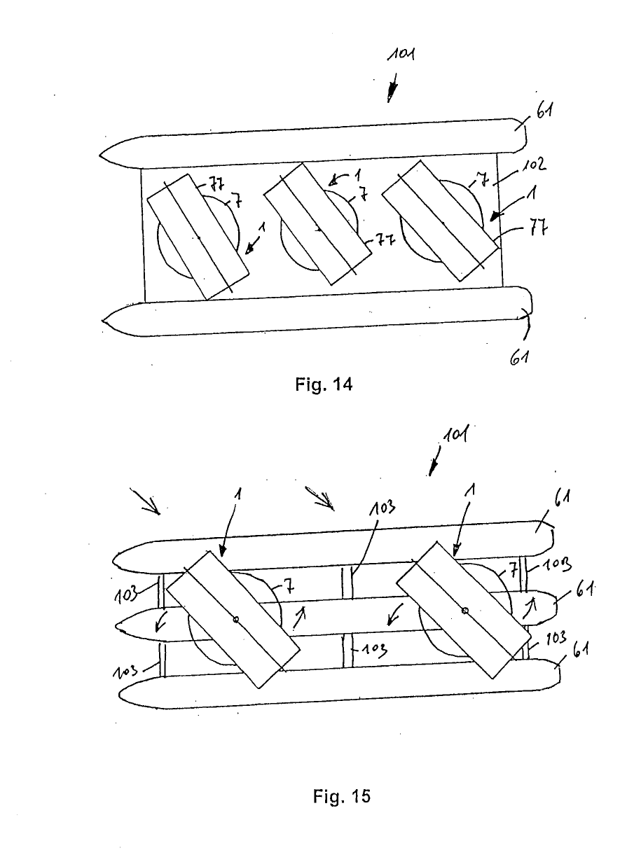

FIG. 14 is a diagrammatic top-down view of a second embodiment of the system in accordance with the invention with a hull featuring two floats;

FIG. 15 is a diagrammatic top-down view of a third embodiment of the system in accordance with the invention with a hull featuring three floats;

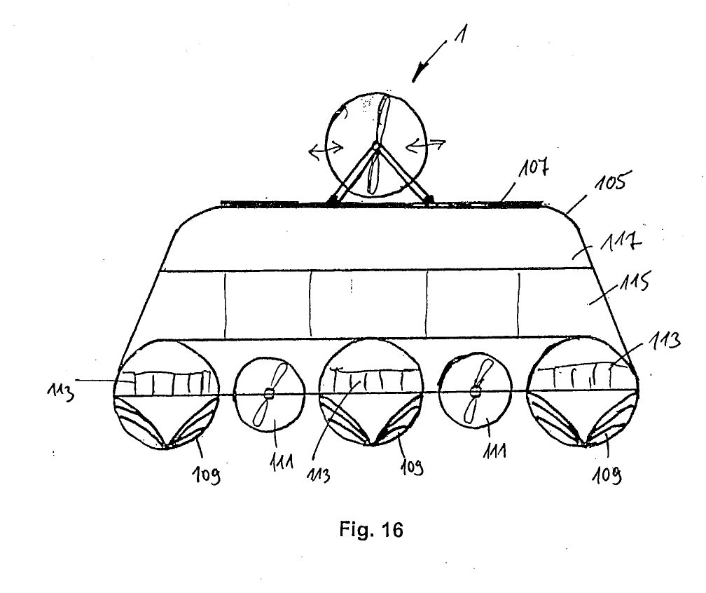

FIG. 16 is a diagrammtic front/partial section view of use of a device in accordance with the invention on a ship having a plurality of floats; and

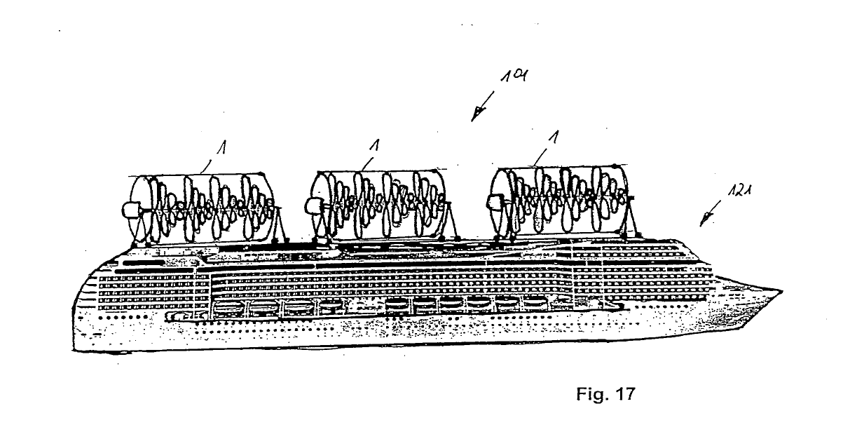

FIG. 17 is a diagrammatic side view of use of a plurality of devices in accordance with the invention or of a system formed thereby on a larger ship with a single float.

Like components as shown in the FIGs. are identified in the following description by like reference numerals.

Referring now to FIG. 1 there is illustrated a first embodiment of a wind-powered device 1 in accordance with the invention for producing regenerative and renewable energy in a side view. As shown in FIG. 1 the device 1 in accordance with the invention comprises a generator 3 which in the example aspect is connected via a gearbox 4 and belt 6 to a drive shaft 5. The belt may be a flat, vee or also a ribbed belt.

At its end portions the drive shaft 5 runs in bearings 13 and furthermore in bearings 87, all bearings being supported by means of mounts 79.

As evident from FIG. 1 furthermore the device in accordance with the invention comprises in this embodiment buoyancy objects or floats 61 as are better evident from FIG. 2 in side view taken along the line II-II in FIG. 1.

As furthermore evident from FIG. 1, arranged along the drive shaft 5 is a plurality of repellers 19 same shaped as propellers. Each repeller 19 comprises two blades 21 offset by 180° which are set rotating by the passing air. As already mentioned, the repellers 19 may also comprise just a single blade or more than two blades 21.

The blades 21 and the repellers 19 respectively are arranged staggered along the drive shaft 5 as further detained below.

Preferably the floats 61 are provided with a tether 63 enabling the device 1 in accordance with the invention to be oriented facing the wind as indicated by the arrow 10. To assist this orientation the device 1 in accordance with the invention features a rudder assembly 14 with the aid of which the device in accordance with the invention is oriented facing the flow of air.

Referring now to FIG. 2 there is illustrated furthermore clearly how simple the device in accordance with the invention is engineered. The two floats 61 are connected by at least one connecting means 16, for example in the form of a cross-strut and the frame mounts 79 are correspondingly supported by the floats 61.

As indicated by the arrow 18 the blades 21 of the device in accordance with the invention rotate counter-clockwise, the blades as shown in FIG. 2 being arranged staggered, this being along the drive axis 5 as shown in FIG. 1 resulting in the contour as shown there.

It is of course just as possible that the blades 21 can be arranged otherwise, both as regards their spacing along the drive axis 5 and also as regards their pitch relative to each other. In other words the blades 21 of one repeller 19 are pitched relative to the blades 21 of the next repeller 19 adjustable to achieve an optimum transmission of power of the medium flowing by.

Referring now to FIG. 3 there is illustrated diagrammatically optimum possibilities for adjusting the blades 21 of the repellers 19 on the drive shaft 5.

To advantage each blade 21 runs rotatable about as indicated by the double arrow 39 in a bearing element 41 so that each blade face 22 of each blade can be individually pitched into the flow of the passing air.

Furthermore the repellers 19 can be set spaced away from each other along the drive shaft as indicated by the double-arrows 43. The possibilities as shown in FIG. 3 are merely examples and the arrangement of the individual repellers 19 does not correspond to their real setting, the double-arrows 45 indicating their rotatability as shown in FIGS. 1 and 2, for example.

This possibility for an optimum setting as achieved in accordance with the invention results in the flow-mechanical response along the drive shaft being utilized optimally with the additional possiblity of using not just identical blades as shown in FIG. 3 but also differing blades having differing blade faces permitting optimization of the device in accordance with the invention.

Referring now to FIG. 4 there is illustrated a diagrammatic view in perspective of a design embodiment of the drive shaft 5 featuring a splined shaft 40 comprising a longitudinal arrangement of splines as is better evident from FIG. 5 showing the configuration in an exploded view. The bearing element 41 is devised split with two bearing shells 47, each of which comprises a splined inner contour mating with the splines of the splined shaft 40 to positively clasp the splined shaft 40.

Inserted in each bearing shell 47 is a mounting bush 48. In this arrangement the axes of the bushes 48 are inline so that the blades 21 are arranged precisely offset by 180 deg. Internally the mounting bushes 48 feature a splined profile positively mating with a splined profile of a gearbox 49 of each blade 21. This positive splined connection enables the blades 21 to be positioned turned as wanted whilst making it very simple to stagger a pair of blades 21 relative to the adjoining pair(s) by staggering the bearing shell 47 about the splined shaft 40. Conventional fasteners 51 involving nuts and bolts serve to secure the bearing shells 47 to each other and respectively the mounting bushes 48 to the bearing shells.

Referring now to FIG. 6 there is illustrated a first embodiment of the device 1 in accordance with the invention, the arrangement of the repellers 19 or blades 21 corresponding to the arrangement as shown in FIG. 1, of which FIG. 6 is a front view.

Referring now to FIG. 7 there is illustrated how the device 1 in accordance with the invention comprises a frame 7 configured substantially circular, mounted to rotate about an axis of rotation 8 to thus make it possible to rotate the device in accordance with the invention about the axis of rotation 8 in the direction of the blade face 22 to thus optimally orient the device into the flow as indicated by arrow 10 as assisted by the rudder assembly 14.

Referring now to FIGS. 8 to 10 there is illustrated an alternative embodiment of the device in accordance with the invention, FIG. 8 showing a view in perspective, FIG. 9 a front view and FIG. 10 a side view.

Referring now to FIGS. 11a to 11c there is illustrated two blades 24 of a repeller on a magnified scale, offset to each other by 180°, forming together a tubular profile 26 in which an elongated cavity 28 is configured. This elongated cavity 28 is sealed off from the ambience and comprises a fluid 30, preferably water which does not completely fill the cavity 28, but substantially only by half. When the blades 24 of a pair forming the tubular profile 26 turn from the horizontal position as shown in FIG. 11a in which the fluid 30 is accommodated substantially equally distributed in the cavity 28, to one side as indicated by the arrow 32 the fluid 30 is abruptly moved by the force of gravity into the partial cavity (see FIG. 11b) being lowered, resulting in the corresponding blades 24 being suddenly torqued. FIG. 11c shows the filled cavity 28 in its lowest position turning further again into the position as shown in FIG. 11a, and so forth.

Referring now to FIGS. 12a to 12c there is illustrated a variant of the embodiment as shown in FIGS. 11a to 11c. provided at the sides and ends of the blades 24 are vane-type tips 34 making for an even better blade face especially when the incident flow is less, i.e. the aspect variants as shown in FIGS. 8 to 12c are thus particularly suitable with a low incident flow.

Referring now to FIG. 13 there is illustrated in a diagrammatic top-down view a system 101 in accordance with the invention. The system 101 comprises two devices in accordance with the invention, each including a duct 77 housing at least the drive shaft 5 and the blades 21 and repellers 19 respectively. The devices comprise a frame 7 permitting rotation of the duct 77 to permit adapting to the direction of the air flow as indicated by arrow 104. The devices 1 are arranged on a hull 60 functioning as a floats 61. The generator can be sited either in or external to the duct 77. The devices 1 serve offshore energy production, the energy produced by the generator(s) being fed via corresponding power cables into the connected power grids.

As an alternative, the energy produced by the system 101 or devices 1 may also serve to propel the hull 60 which can move in the wanted direction, for example as indicated by the arrows 106 irrespective of the direction of the wind 104.

Referring now to FIG. 14 there is illustrated a second embodiment of the system 101 in accordance with the invention, comprising three devices 1 arranged on a platform 102 mounted in turn on two floats 61. The arrangement of these two floats 61, similar to a katamaran, makes the embodiment of the system in accordance with the invention as shown in FIG. 14 particularly suitable for offshore energy production facilities.

Referring now to FIG. 15 there is illustrated a third embodiment of the system 101 in accordance with the invention configured as a trimaran with three floats 61 connected in parallel by suitable struts 103. Two energy production devices are arranged on rotating frames 7 on the middle float 61.

Referring now to FIG. 16 there is illustrated diagrammatically how the device 1 in accordance with the invention is used to propel a large ship 105.

The device is arranged on the roof 107 of the ship 105 which is configured like a trimaran comprising three floats 109 which may be shaped correspondingly as known.

Shown in FIG. 16 is a front/partial section view of a ship 105, the drives of which are preferably arranged aft of the floats 109 with the possibility of additional propelling drives 111 being provided.

Accommodated in the floats 109 are accumulators 113 capable of storing the energy generated by the device 1 and making the energy available to the drives, for example 111.

The ship 105 may comprise a deck 115 for cargo, such as, for example, containers, motor vehicles, etc and a passengers deck 117.

It is, of course, just as possible to extend the device 1 in accordance with the invention by a system in accordance with the invention consisting of a plurality of devices 1 to furnish the energy needed to propel the ship which can serve to be fed to accumulators and/or direct to the propulsion system of the ship via corresponding electric motors.

In addition, the device 1 in accordance with the invention may serve instead of, or also to furnish or generate energy for other energy consumers on board ship such as lighting, heating and the like.

Referring now to FIG. 17 there is illustrated in a side view a larger ship 121, here in the form of a passenger ship, on the roof of which a system 101 in accordance with the invention comprising three devices 1 is arranged, each of which is likewise mounted on rotatable frames to face the prevailing wind. The advantage of the device and system in accordance with the invention becomes all the more clear when compared to the so-called Flettener rotor which is arranged substantially vertically, there being no risk with the device and system in accordance with the invention of the ship heeling over as with a Flettner rotor causing the ship to heel prompted by wind impact.

The wind-powered device in accordance with the invention for producing regenerative and renewable energy achieves a wealth of advantages, including:
simple and easy to install without involving construction activities, thus making it available with minimum delay;
regional basic supply possible by being sited near to power consumers;
full system configured modular by a plurality of single devices to optimally exploit the air flow as a function of the conditions in situ;
universal and, where necessary, automatic adaptation of the device to existing flow conditions in thus assuring optimized response of the device in accordance with the invention;
environmentally friendly energy production;
device can be sized optimized to the energy supply required, for example case-sized set for siting in remote communities and the like:
service can be adapted to any flow of water and diverse flow conditions;
zero-emission energy production including power for propelling ships of all kinds;
depending on the embodiment it can be encapsulated for particularly low-noise operation.

1-22. (canceled)

23. A wind-powered device for producing regenerative and renewable energy, the device comprising
at least one generator for producing electric energy;
a drive shaft connected to the generator;
a plurality of blades, which are set rotating by passing air, the blades being arranged interstaggered along the drive shaft,
wherein the blades are configured repeller-type and the pitch of the blades is interadjustable.

24. The device of claim 23, wherein the spacing of the blades is adjustable in the longitudinal direction of the drive shaft.

25. The device of claim 23, wherein the pitch of the blade face is adjustable relative to the drive shaft.

26. The device of claim 23, wherein adjusting the blades is computer-controlled, the adjustment being by mechanical, electromechanical, pneumatic or hydraulic means.

27. The device of claim 23, wherein the blades are releasably fitted to the drive shaft.

28. The device of claim 23, wherein the drive shaft is directly connected to the generator.

29. The device of claim 23, wherein the drive shaft is mounted in a frame.

30. The device of claim 29, wherein the frame is arranged substantially horizontal rotatable about a vertical axis.

31. The device of claim 30, wherein the frame is arranged in a duct.

32. The device of claim 23, wherein the device is arranged above the hull of a ship and further comprises one or more buoyancy objects or floats and a tether.

33. The device of claim 32, wherein the device further comprises a self-orienting rudder assembly.

34. The device of claim 23, wherein the drive shaft comprises bearings at both ends and at least one further location between the ends.

35. The device of claim 34, wherein the bearings are oil-less, sealed-for-life plain or ball bearings made of plastic or ceramic.

36. The device of claim 23, wherein the drive shaft is engineered as a splined shaft and the mount of each blades is a splined mount.

37. The device of claim 23, further comprising a mesh cage surrounding the device.

38. The device of claim 23, wherein two each blades offset by 180° form a common tubular profile comprising a cavity in which a fluid is accommodated.

39. The device of claim 38, wherein the fluid in the cavity is water.

40. The device of claim 38, wherein the fluid fills substantially half of the cavity.

41. A wind-powered system for producing regenerative and renewable energy, the system comprising a plurality of devices, each device comprising
at least one generator for producing electric energy;
a drive shaft connected to the generator;
a plurality of blades which are set rotating by passing air, the blades being arranged interstaggered along the drive shaft,
wherein the blades are configured repeller-type and the pitch of the blades is interadjustable,
wherein the plurality of devices are arranged one behind the other and/or alongside each other and/or above each other.

42. The system of claim 41, wherein the drive shafts of the devices are interconnected universally.

43. A method of propelling a ship, the method comprising
generating energy from a device comprising
at least one generator for producing electric energy;
a drive shaft connected to the generator;
a plurality of blades which are set rotating by passing air, the blades being arranged interstaggered along the drive shaft,
wherein the blades are configured repeller-type and the pitch of the blades is interadjustable; and
providing the generated energy to an electric motor, the electric motor capable of driving screws for propelling a ship.

44. The method of claim 43, wherein a plurality of devices are arranged one behind the other and/or alongside each other and/or above each other.
